(19) United States
(12) Patent Application Publication
(10) Pub. No.: US 2012/0113229 A1
(43) Pub. Date: May 10, 2012

(54) Rotate and Hold and Scan (RAHAS) Structured Light Illumination Pattern Encoding and Decoding

(75) Inventors: Laurence G. HASSEBROOK, Lexington, KY (US); Charles Joseph CASEY, Lexington, KY (US); Eli Ross CRANE, Lexington, KY (US); Walter F. LUNDBY, Wheaton, IL (US)

(73) Assignee: UNIVERSITY OF KENTUCKY RESEARCH FOUNDATION (UKRF), Lexington, KY (US)

(21) Appl. No.: 13/168,933

(22) Filed: Jun. 24, 2011

Related U.S. Application Data
(60) Provisional application No. 61/358,397, filed on Jun. 24, 2010.

(51) Int. Cl. H04N 13/02

(52) U.S. Cl. 348/47; 348/E13.074

(57) ABSTRACT

A unique computer-implemented process, system, and computer-readable storage medium having stored thereon, executable program code and instructions for 3-dimentional (3-D) image acquisition of a contoured surface-of-interest under observation by at least one camera and employing a preselected SLI pattern. The system includes a 3-D video sequence capture unit having (a) one or more image-capture devices for acquiring video image data as well as color texture data of a 3-D surface-of-interest, and (b) a projector device for illuminating the surface-of-interest with a preselected SLI pattern in, first, an initial Epipolar Alignment and ending in alignment with an Orthogonal (i.e., phase) direction, and then shifting the preselected SLI pattern (‘translation’). A follow-up ‘post-processing’ stage of the technique includes analysis and processing of the 3-D video sequence captured, including the steps of: identification of Epipolar Alignment from the 3-D video sequence, tracking ‘snakes’/stripes from the initial Epipolar Alignment through alignment with the Orthogonal direction, tracking ‘snakes’/stripes through pattern shifting/translation; correcting for relative motion (object motion); determining phase and interpolating adjacent frames to achieve uniform phase shift; employing conventional PMP phase processing to obtain wrapped phase; unwrapping phase at each pixel using snake identity; using conventional techniques to map phase to world coordinates.

### PRIORITY BENEFIT TO CO-PENDING PATENT APPLICATIONS

This application claims benefit of pending U.S. Provisional Patent Application No. 61/358,397 filed 24 Jun. 2011 describing developments of the applicants hereof, on behalf of the assignee. The specification, drawings, and technical EXAMPLE materials of U.S. Prov. Pat. App. No. 61/358,397 are hereby incorporated herein by reference, in their entirety, to the extent each provides further edification of the advancements set forth herein.

### BACKGROUND OF THE INVENTION

### Field of the Invention

In general, the present invention relates to computer implemented digital structured light illumination (SLI) systems and techniques for performing three-dimensional (“3-D”) image acquisition to digitize an artifact feature or contoured surface. More-particularly, the invention is directed to a unique computer-implemented process, system, and computer-readable storage medium having stored thereon, executable program code and instructions for 3-dimentional (3-D) image acquisition of a contoured surface-of-interest under observation by at least one camera and employing a preselected SLI pattern. The system includes a 3-D video sequence capture unit having (a) one or more image-capture devices for acquiring video image data as well as color texture data of a 3-D surface-of-interest, and (b) a projector device for illuminating the surface-of-interest with a preselected SLI pattern in, first, an initial Epipolar Alignment and ending in alignment with an Orthogonal (i.e., phase) direction, and then shifting the preselected SLI pattern (‘translation’ step).

A follow-up ‘post-processing’ stage of the technique includes analysis and processing of the 3-D video sequence captured, including the steps of: identification of Epipolar Alignment from the 3-D video sequence, tracking ‘snakes’/stripes from the initial Epipolar Alignment through alignment with the Orthogonal direction, tracking ‘snakes’/stripes through pattern shifting/translation; correcting for relative motion (object motion); determining phase and interpolating adjacent frames to achieve uniform phase shift; employing conventional PMP phase processing to obtain wrapped phase; unwrapping phase at each pixel using snake identity; using conventional techniques to map phase to world coordinates. See the flow diagram in FIG. 12 for reference.

Rotate and Hold and Scan (RAHAS) is a phrase coined by applicants for their unique SLI technique and associated system. In a preferred embodiment the technique employs mathematical ‘snake tracking’—likewise coined by applicants and further detailed in U.S. Pat. App. 12/284,253 entitled “Lock and Hold Structured Light Illumination” filed by two named applicants hereof on 18 Sep. 2008, and commonly owned by the assignee of the instant application. As explained in further detail elsewhere, ‘snake tracking’ is used in connection with the instant invention to identify the projected pattern stripes to remove ambiguities from a traditional Phase Measuring Profilometry (PMP) scan.

The acronym RAHAS, as coined by applicants and used herethroughout, recognizes three types of movement of a preselected SLI pattern across the object: Rotate, Hold, and Scan (e.g., see graphical representations labeled FIGS. 4-8). It is the use of an initial Epipolar Alignment of the SLI pattern projected at the contoured surface-of-interest that allows for identification of the stripes (‘snakes’) to be known. The term Epipolar Alignment refers to the orientation of pattern stripes along the line that is drawn through both the projector and camera optical centers. This alignment is considered a keystone alignment, as it removes the depth variation of the stripes and they appear straight, which allows for explicit identification in Post-processing.

The unique computer-implemented process, system, and computer-readable storage medium having stored thereon, executable program code and instructions, can be characterized as having a couple of stages: an on-site 3-D video sequence capture—or data collection—stage (FIG. 6) employing a unique image data capture unit to collect at least one video sequence while illuminating the surface-of-interest with a preselected SLI pattern (a sinusoidal pattern or such, or a more-complex composite pattern such as that contemplated by U.S. Pat. Nos. 7,844,079 B2 and 7,440,590 B1 detailed below); and a post-processing stage FIG. 12 whereby computer processing of the video sequences captured is performed.

SLI works by measuring the deformation of a light pattern that has been projected on the surface contours of an object. The pattern is used to identify the points in camera coordinates; mathematical operation is performed to find the position of each point in 3-D space. There are a variety of SLI pattern types in use: single dimensioned lines, two dimensioned stripes, grids or dot matrices. For example, the unique composite SLI patterns may be employed as disclosed in U.S. Pat. No. 7,844,079 B2 granted 30 Nov. 2010 to Hassebrook et al. and U.S. Pat. No. 7,440,590 B1 granted 21 Oct. 2008 to Hassebrook et al., both patents having at least one common inventor with the instant application and commonly-owned with the instant application upon filing, and both patents entitled “System and Technique for Retrieving Depth Information about a Surface by Projecting a Composite Image of Modulated Light Patterns.”

### General Discussion of Technology: An Historical Perspective

SLI measurement is based on the mathematical operation known as triangulation. Results are useful when there is a well defined relationship between a single point on the projection plane of interest and a corresponding point on a captured image. It is to establish this relationship that SLI projection patterns are utilized. An SLI projection pattern is preferably designed such that each pixel (or row or column, depending on the specific implementation) of the projection image is uniquely characterized, either by some characteristic intensity value sequence or by some other identifiable property such as a local pattern of shapes or colors. When projected onto a subject of interest, an image of the pattern illuminating a projection plane of interest captured by a camera is analyzed to locate these identifiable projection pattern points. Given a fixed location for both camera and projector, the location of any given pattern point on the subject creates a unique triangle with dimensions defined by the depth of the subject surface.

SLI systems are further classified into single-frame techniques, which require only one image capture to calculate surface characteristics, and multi-frame (or “time multiplexed”) techniques, which require multiple projection/capture instances in order to acquire enough information for surface reconstruction.

Hassebrook, et al. U.S. patent application 12/284,253 “Lock and Hold Structured Light Illumination” explains the various aspects of their technique, system and program code for 3-dimentional image acquisition of a surface-of-interest under observation by at least one camera using structured light illumination, as follows:
illuminating the surface-of-interest, while static/at rest, with structured light to obtain initial depth map data therefor; while projecting a hold pattern comprised of a plurality of snake-stripes at the static surface-of-interest, assigning an identity to and an initial lock position of each of the snake-stripes of the hold pattern; and while projecting the hold pattern, tracking, from frame-to-frame each of the snake-stripes. Another aspect includes: projecting a hold pattern comprised of a plurality of snake-stripes; as the surface-of-interest moves into a region under observation by at least one camera that also comprises the projected hold pattern, assigning an identity to and an initial lock position of each snake-stripe as it sequentially illuminates the surface-of-interest; and while projecting the hold pattern, tracking, from frame-to-frame, each snake-stripe while it passes through the region. Yet another aspect includes: projecting, in sequence at the surface-of-interest positioned within a region under observation by at least one camera, a plurality of snake-stripes of a hold pattern by opening/moving a shutter cover; as each of the snake-stripes sequentially illuminates the surface-of-interest, assigning an identity to and an initial lock position of that snake-stripe; and while projecting the hold pattern, tracking, from frame-to-frame, each of the snake-stripes once it has illuminated the surface-of-interest and entered the region.

The in-process manuscript labeled herein as “ATTACHMENT A” titled Methodology and Technology for Rapid Three-Dimensional Scanning of In Situ Archaeological Materials in Remote Areas was authored by the applicants hereof and labeled “EXAMPLE A.” as an integral part of applicants' pending U.S. provisional Pat. App. No. 61/358,397—to which the instant application claims priority. Not only does their provisional app. EXAMPLE A. manuscript highlight implementation of RAHAS in the practice of archaeology, but it also highlights the rigorous analysis done by applicants in developing their innovative RAHAS approach; further evidencing the complex, multifaceted nature of problems encountered by those attempting to create solutions in the arena of 3-D image acquisition employing SLI.

Archaeology faces unique challenges among the historical sciences in that much of the accepted methodologies used are destructive to the archaeological resources. From excavation to surface collections, nearly all archaeological fieldwork impacts the resources. This also applies to the deterioration of artifacts during their study through handling by various researchers and shipment between research groups. The technique and system of the invention is adapted for use in the area of archaeology to produce 3-D digitized images of artifacts and other shapes and surfaces located outdoors, inside building structures, and immersed underwater, whether retained untouched, in their native state, or removed and stored or displayed elsewhere. Since the unique 3-D video sequence unit of the system has a small processing footprint, it is useful for 3-D image acquisition where system weight/portability is a concern, conditions are harsh, and/or electrical power resources are scarce or nonexistent. While the 3-D surface acquisition technology disclosed herein will assist archaeologists—especially those working in remote locations—face these challenges, the technique and system of the invention have a multitude of uses and applications beyond archeology, such as to catalog and digitize 3-D surfaces or contours of all sorts whether above-ground, underground, underwater, in outer space, and whether composed of living matter, manmade structures, artwork, mammal anatomy (e.g., faces), and such.

### Background: Computerized Devices, Memory & Storage Devices/Media.

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of control units, input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.

II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—more-recently, the definitions of these terms have blurred. A non-exhaustive listing of well known computer readable storage device technologies compatible with a variety of computer processing structures are categorized here for reference: (1) magetic tape technologies; (2) magnetic disk technologies include floppy disk/diskettes, fixed hard disks (often in desktops, laptops, workstations, etc.), (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, and so on.

### SUMMARY OF THE INVENTION

Briefly described, once again, the invention includes a unique computer-implemented process, system, and computer-readable storage medium having stored thereon, executable program code and instructions for 3-dimentional (3-D) image acquisition of a contoured surface-of-interest under observation by at least one camera and employing a preselected SLI pattern. The system includes a 3-D video sequence capture unit having (a) one or more image-capture devices for acquiring video image data as well as color texture data of a 3-D surface-of-interest, and (b) a projector device for illuminating the surface-of-interest with a preselected SLI pattern in, first, an initial Epipolar Alignment and ending in alignment with an Orthogonal (i.e., phase) direction, and then shifting the preselected SLI pattern (‘translation’ step). A follow-up ‘post-processing’ stage of the technique includes analysis and processing of the 3-D video sequence captured.

### BRIEF DESCRIPTION OF DRAWINGS/INCORPORATION OF ATTACHMENT(S)

For purposes of illustrating the innovative nature plus the flexibility of design and versatility of the new system and associated technique, as customary, figures are included. One can readily appreciate the advantages as well as novel features that distinguish the instant invention from conventional computer-implemented 3D imaging techniques. The figures as well as any incorporated technical materials have been included to communicate the features of applicants' innovation by way of example, only, and are in no way intended to limit the disclosure hereof. Each item labeled an ATTACHMENT is hereby incorporated herein by reference for purposes of providing background technical information.

FIGS. 1A, 1B, 1C diagrammatically depict video sequence capture unit 100.

FIGS. 2A, 2B diagrammatically depict an alternative video sequence capture unit 200.

FIG. 3 is a high-level diagram depicting a projection unit 30, 130 of a capture unit.

FIGS. 4 and 5 are diagrams depicting features of the technique of the invention.

FIG. 6 depicts features/components employed to implement method of the on-site capture process.

FIGS. 7 and 8 graphically depict, by way com computer-generated/implemented images shown in sequence (follow arrows), the process of snake tracking of the projected pattern stripes.

The flow diagram FIG. 9 gives an overview of the Post-processing of the 3-D video sequence acquired on-site.

FIG. 10 graphically represents time-varying signal at a pixel: A representation of the sinusoidal signal at a pixel, and how it changes with non-constant pattern motion.

FIG. 11 is a graphic (computer-generated/implemented images) demonstration of the “un-rotation” of the pattern sequence with the same images from FIG. 4 (a, b, and c).

FIG. 12 is a flow diagram highlighting features of the Post-processing stage.

FIG. 13 is a flowchart representing the SnakeFind_init2Snake function

FIG. 14 is a flowchart of the SnakeFind_growLeft/Right function.

An overview of the overall snake tracking process is presented in FIG. 15.

FIG. 16 is a flowchart illustrating the SnakeFind_trackDeltaY function.

A visual representation of the phase shift estimating process is shown in FIG. 17.

FIG. 18 shows a typical wrapped phase image and the corresponding unwrapped phase image generated using Equation 3.21; FIG. 18(a) wrapped phase and FIG. 18(b) unwrapped phase. The wrapped phase image (a) is shown with four of the phase bands colored.

FIG. 19 graphically depicts Phase Cross-Sections: FIG. 19(a) is the cross-section of the wrapped phase at the center column; FIG. 19(b) is the unwrapped phase cross section (blue) is shown along side the wrapped phase cross section (black) to demonstrate how the unwrapped phase is a copy of the wrapped phase signal detail in each phase band.

FIG. 20 itemizes steps of an example procedure for setting up and use of ‘scanning’/video sequence capture using a unit 100, 200.

FIG. 21 are digital images (computer generated/implemented) of several objects scanned: FIG. 21(a) two views of a grinding stone from the first site (Cave) that was to be merged; FIG. 21(b) hill scans; and FIG. 21(c) petroglyphs on the rocks in the river that were taken at night.

FIG. 22 shows examples of PMP patterns at three separate frequencies, along with corresponding Phase and Orthogonal Directions. FIG. 22(a) is at a frequency of 1, (b) is at a frequency of 3 and (c) is at a frequency of 10.

To visualize triangulation, the simplistic pinhole model represented in FIG. 23 is used.

FIGS. 24 and 25 are digital images (computer generated/implemented) of several objects scanned as labeled.

FIG. 26 is a flow diagram of the detection of object motion as can be done using cross correlation.

FIG. 27 graphically represents the Image of Radius vs. Rotation Angle: A comparison of the temporal signal at a pixel of a given radius vs. rotation angle from the center of rotation.

ATTACHMENT A, authored by applicants hereof, is an in-process manuscript titled Methodology and Technology for Rapid Three-Dimensional Scanning of In Situ Archaeological Materials in Remote Areas, which was labeled as “EXAMPLE A.” as an integral part of applicants' pending U.S. provisional Pat. App. No. 61/358,397. Just as it served an integral part of applicant's pending provisional Pat. App. No. 61/358,397, the ATTACHMENT A/EXAMPLE A. is incorporated by reference in its entirety, herein.

ATTACHMENT B is an article Kumar, B. V. K. Vijaya and Hassebrook, L., Performance measures for correlation filters, APPLIED OPTICS, Vol. 29, No. 20, pp. 2997-3006 (10 Jul. 1990); provided for its technical background and incorporated by reference, herein.

ATTACHMENT C is an article Li, Jielin, Hassebrook, Laurence G., and Guan, Chun, “Optimized two-frequency phase-measuringprofilometry light-sensor temporal-noise sensitivity,” J. Opt. Soc. Am. A, Vol. 20, No. 1, pp. 106-115 (January 2003); provided for its technical background and incorporated by reference, herein.

### DESCRIPTION DETAILING FEATURES OF THE INVENTION

By viewing the figures incorporated below, and associated representative embodiments, along with technical materials outlined and labeled ATTACHMENT A, ATTACHMENT B, and ATTACHMENT C one can further appreciate the unique nature of core as well as additional and alternative features of the new system and associated technique for 3-D image acquisition disclosed herein. Back-and-forth reference and association will be made to various features identified in the figures.

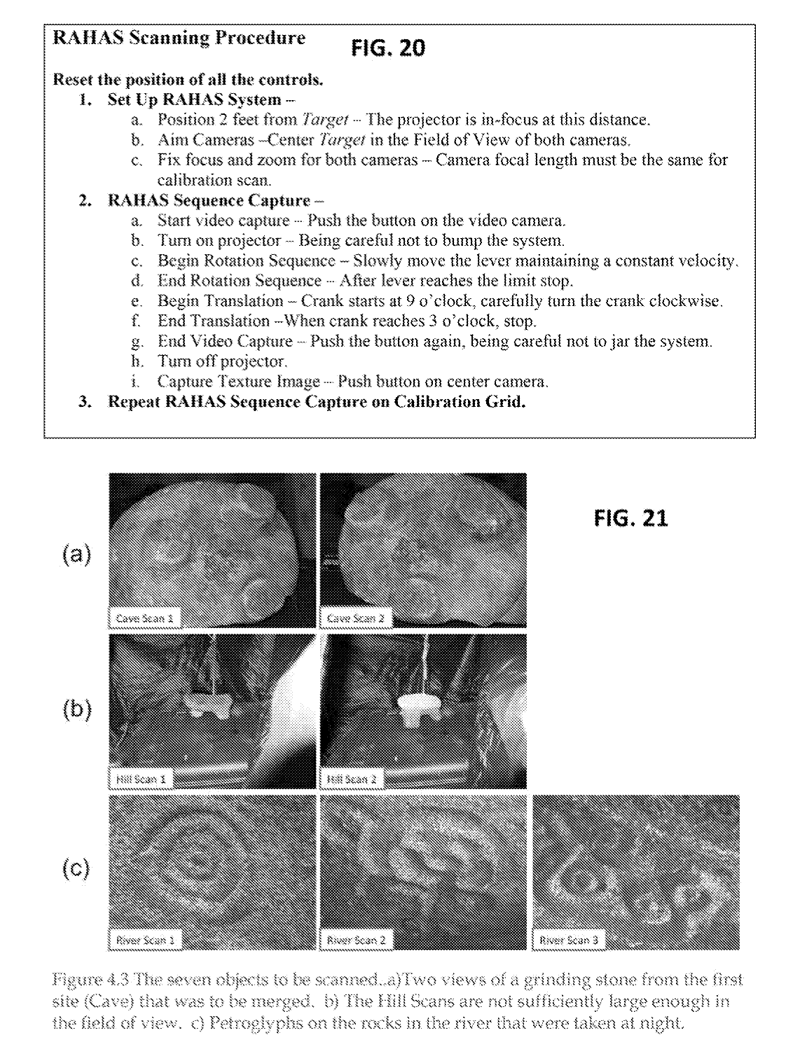

Referring to FIGS. 4-8, the technique begins with a stage/step referred to as “lock”, the identification of the stripes while the pattern is in epipolar alignment. Analogously to the “hold” process, the sinusoidal pattern is then tracked through a rotation of 90 degrees from the epipolar direction to phase alignment, an orientation of maximal depth distortion. The phase alignment allows a translation of the sinusoidal pattern to yield a traditional Phase Measuring Profilometry (PMP) scan, and with the identities of the ‘snakes’/stripes, that correspond to the boundaries for the wrapped phase regions, the ambiguities of the PMP scan can be removed. The motion stages of the capture process (FIG. 6) are summarized, graphically, in FIGS. 4 and 5: (a) ‘snakes’/stripes in epipolar alignment; (b) SLI pattern rotation and recording of snakes for later ‘tracking’, i.e., video data collected with a capture unit 100, 200, is ‘replayed’ and analyzed at a second location having sufficient computer processing equipment and electrical power (see below); (c) ‘snakes’/stripes are shown with maximal distortion during translation of the stripes, accomplished by shifting the pattern in the direction of the arrow, as shown; so phase alignment can be done for PMP upon post-processing.

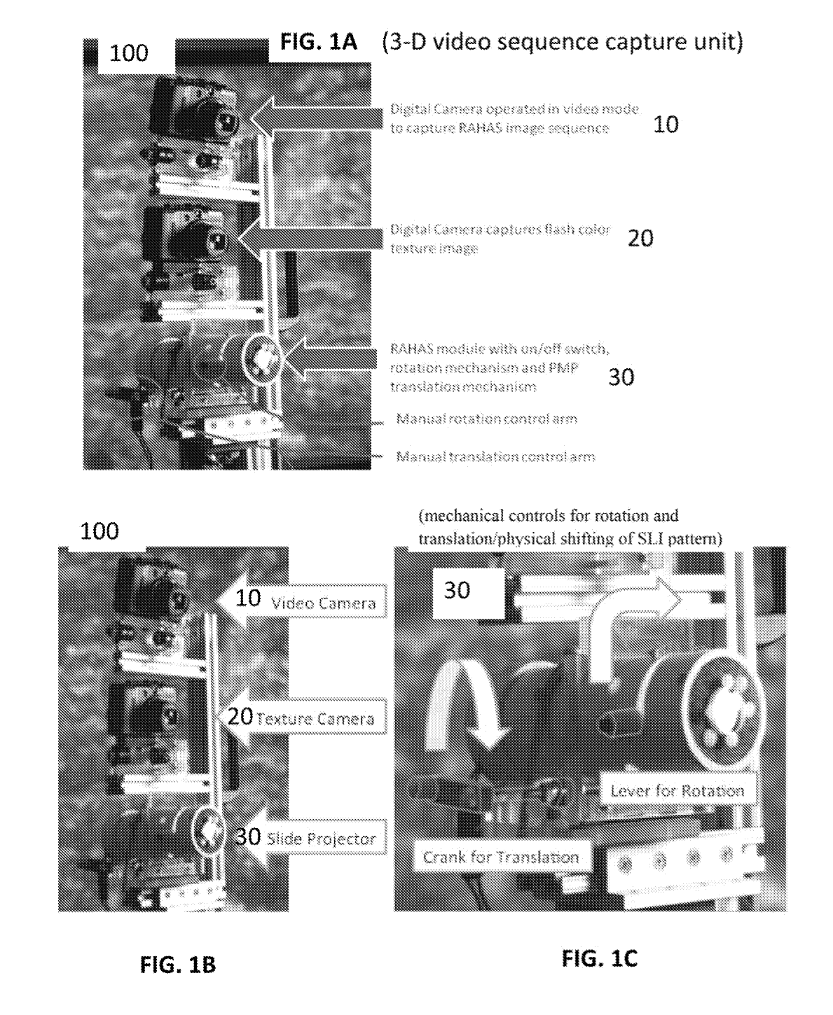

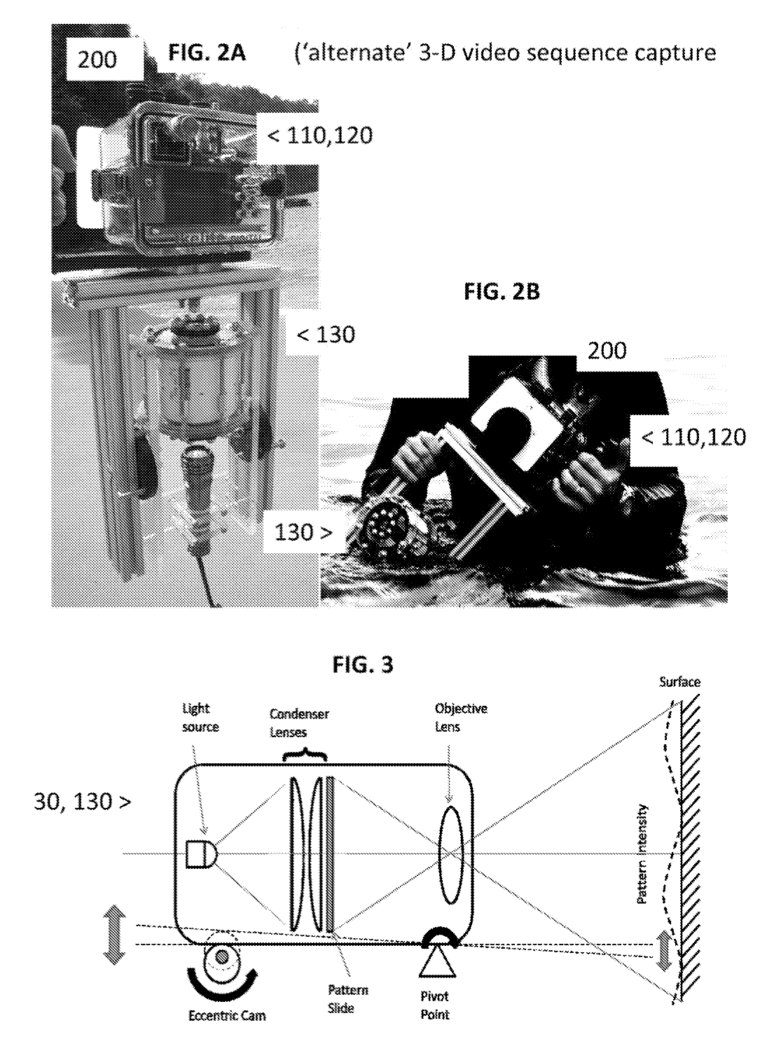

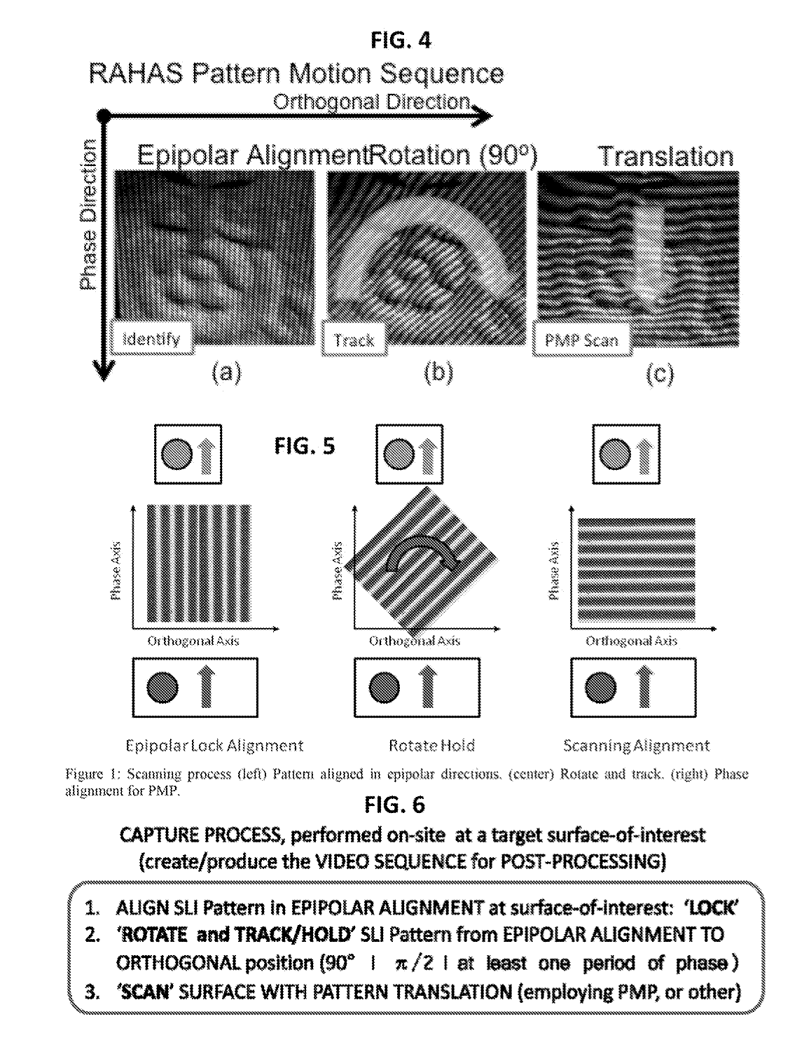

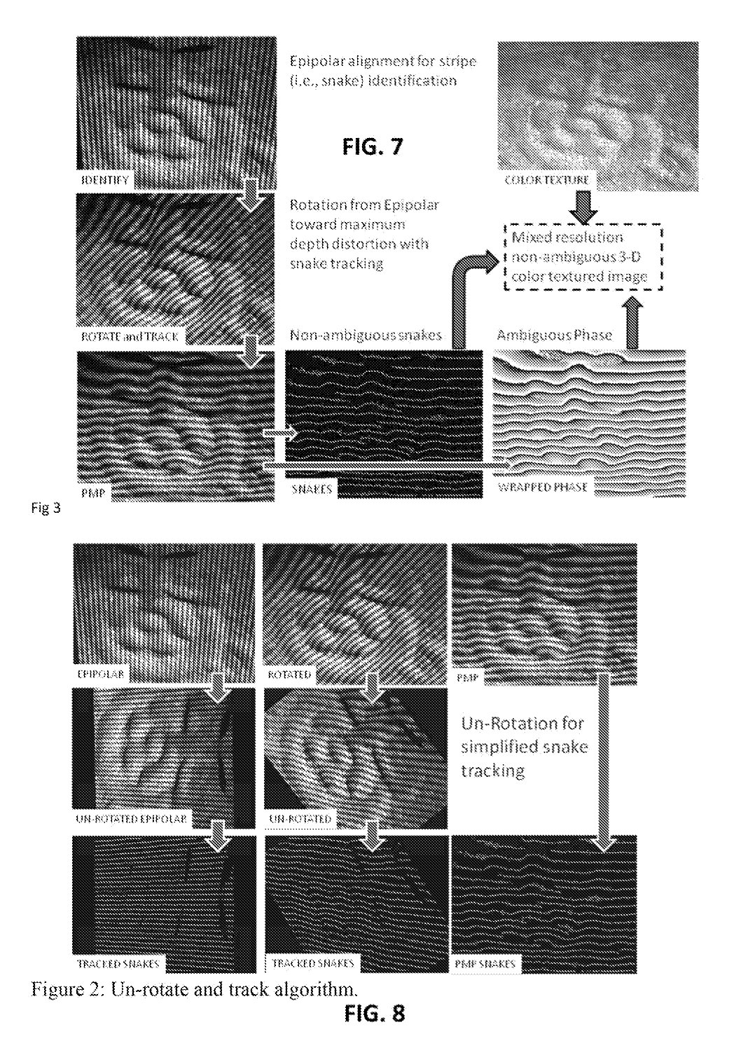

The units 100, 200 depicted in FIGS. 1A-1C and 2A-2B (see chart FIG. 6) is a digital image ‘data collection’ unit; post-processing of the 3-D video sequence data captured ‘on-site’ by a 3-D video sequence capture unit 100, 200 is preferably—in the preferred embodiment—done at a second location with suitable computer processing and electrical power resources, such as back in an office or laboratory with power outlets.

As further highlighted graphically in sequence (follow arrows) in FIGS. 7 and 8, graphic images identified as ‘SNAKE’ can be seen. Snake tracking of the projected pattern stripes is done to allow for non-ambiguous 3-D capture. The pattern projection is initially aligned in the epipolar direction (“IDENTIFY”) for identification of the SLI pattern stripes followed by rotation and stripe tracking to the phase alignment for a more traditional Phase Measuring Profilometry (PMP) movement of the stripe pattern. The stripes are formed from a sinusoidal image projection. The technique can be implemented with a single patterned slide projection or with a digital projection system. A single sinusoidal pattern is shown throughout the figures, by way of example, as the preselected SLI pattern.

In 3-D contour acquisition, it is important to be able to identify each pixel explicitly; this has led to employment of several different temporal and spatial techniques for pattern creation for point discrimination, such as Binary or Gray Scale encoding or PMP. Binary/Gray Scale encoding and PMP employ multiple pattern projections that are time multiplexed, which means that the patterns occur in succession, one after each other. Performing the patterns in succession increases the time to scan for each new pattern that must be included. According to the invention, to save on scanning time and allow real-time processing, the time sequenced pattern can be projected as a single pattern through a technique called composite pattern.

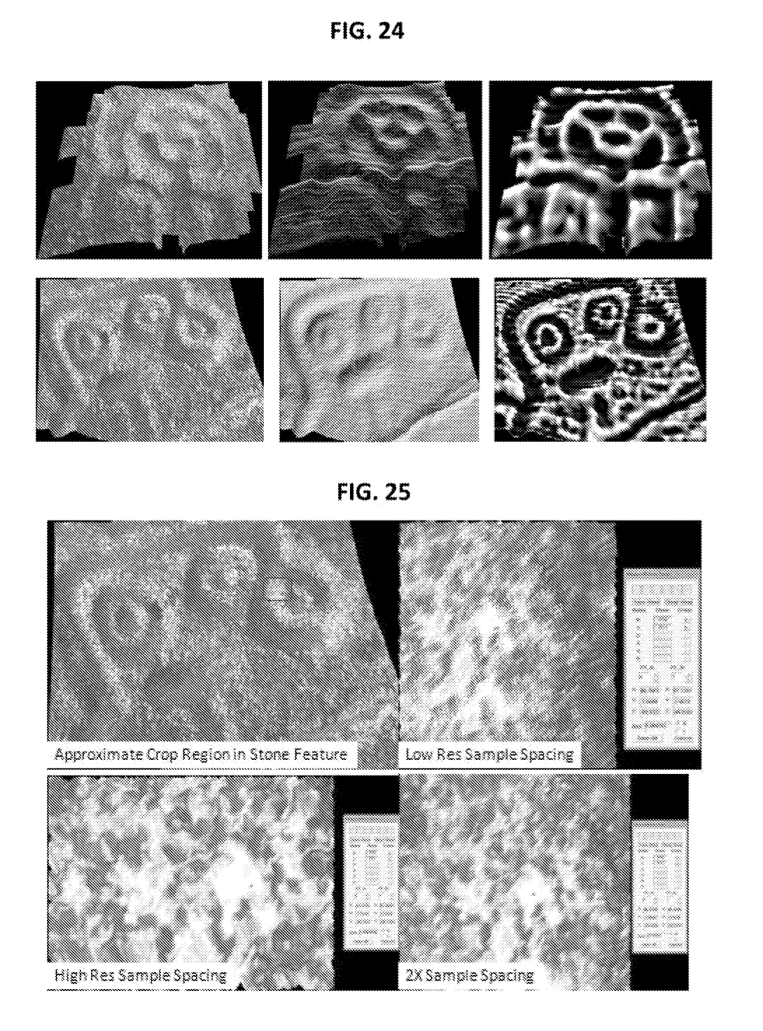

Referring, again, to FIGS. 1A-1C and 2A-2B, the data capture unit 100, 200 ‘scanner’ preferably has three main components: a video camera 10, 110, a high-resolution camera, 20, 120 (the camera units may be separate or features of a single unit as shown in FIGS. 2A-2B), and a slide projector (30, 130). FIG. 20 itemizes steps of an example procedure for setting up and use of ‘scanning’/video sequence capture using a unit 100, 200. By way of example only, FIG. 21 are digital images (computer generated/implemented) of several objects scanned: FIG. 21(a) two views of a grinding stone from the first site (Cave) that was to be merged; FIG. 21(b) hill scans; and FIG. 21(c) petroglyphs on the rocks in the river that were taken at night. FIGS. 24 and 25 are digital images (computer generated/implemented) of several additional objects scanned as labeled, by way of example.

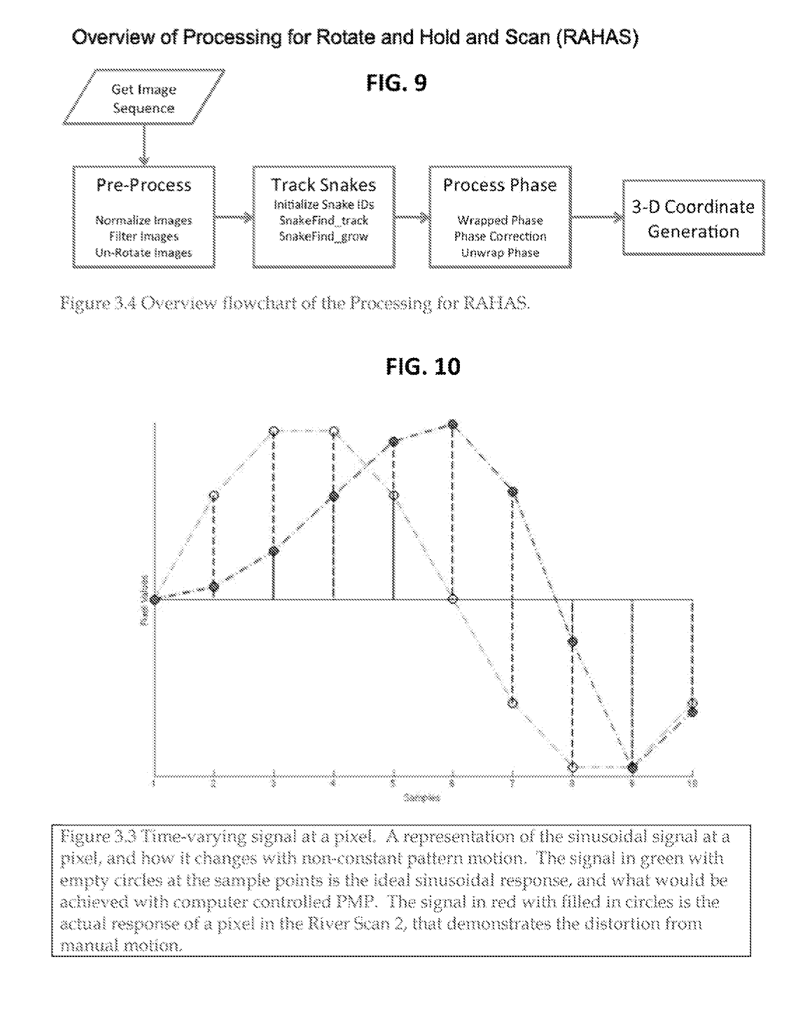

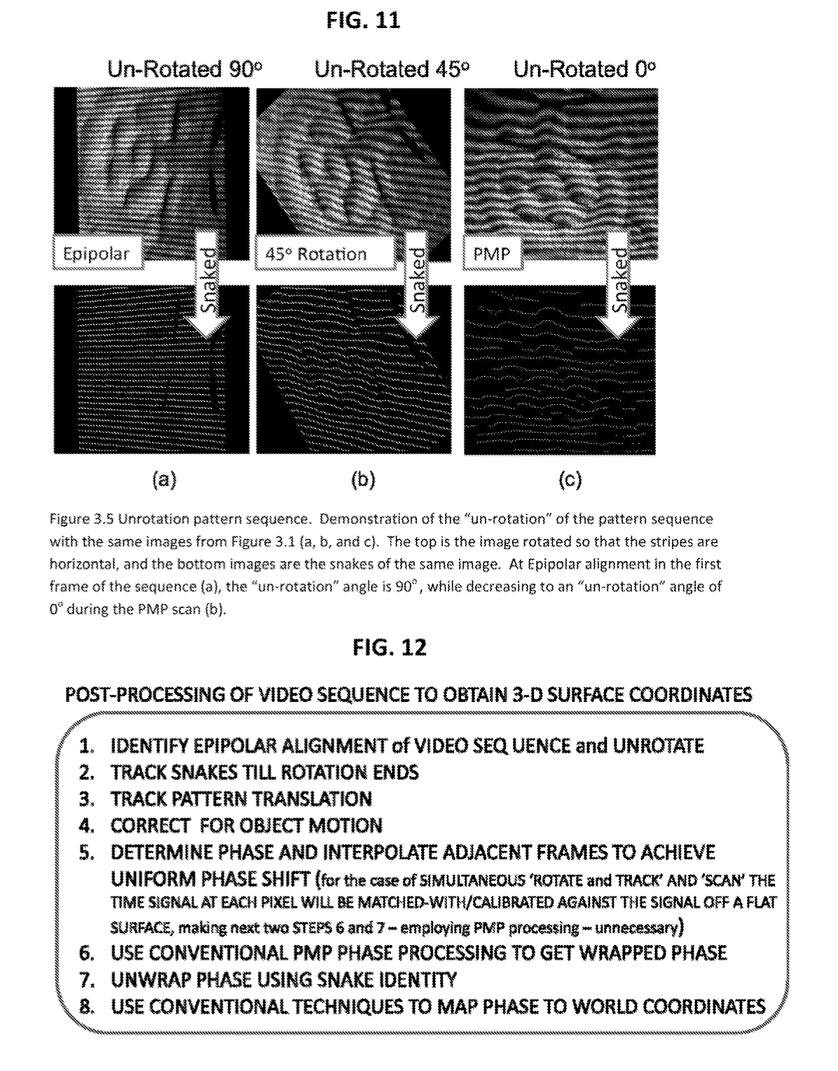

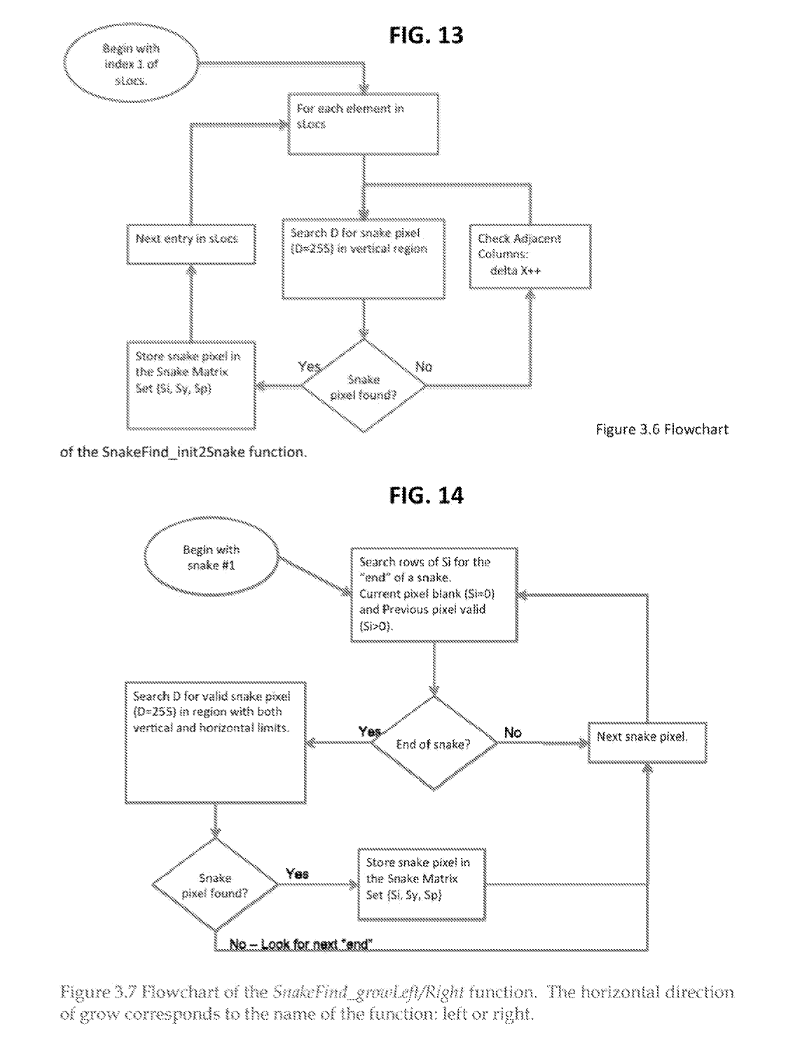

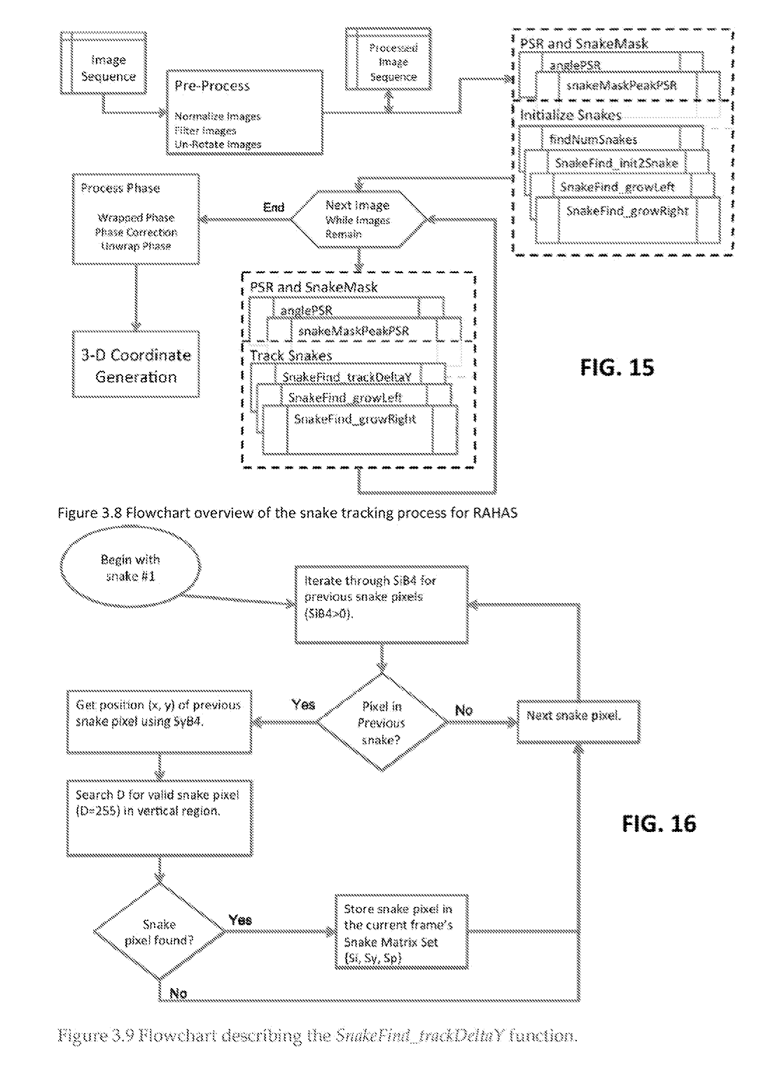

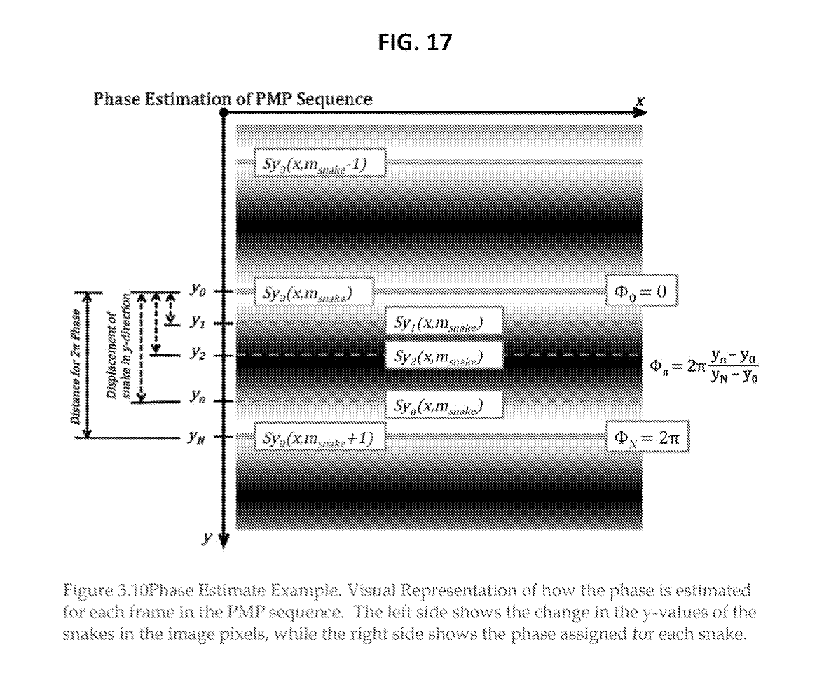

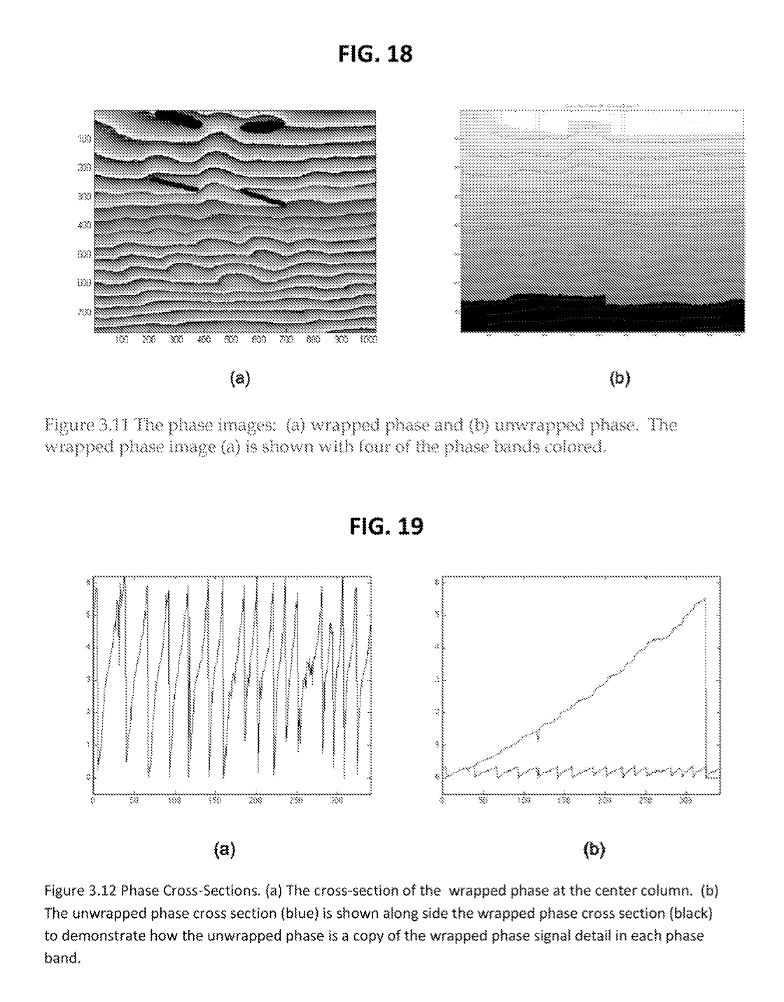

The video camera captures the sequence of images during the pattern motion outlined in FIG. 4, while the high-resolution camera is used to provide the image texture that will be mapped onto the generated 3-D surface using a technique called mixed-resolution (M×R), by way of example. A high-resolution camera can optionally be removed for a more compact unit/scanner, with the texture image being supplied by the video camera. The slide projector 30, 130 (see, also, the schematic side view, FIG. 3 for details) consists of a high lumen LED mounted in a tube with optical lens focusing the light through a mounted slide. By way of example, the motion of the pattern is controlled through the use of a mechanical assembly with two controls: a lever for rotation and a crank for phase translation. The rotation is controlled manually by the physical rotation of a lever attached to the slide carriage mount, which allows for the full 90 degrees of rotation from epipolar alignment to phase alignment. A crank with an attached cam is used for the phase translational motion of the pattern. The crank is turned which spins the cam and forces the slide projector's elevation angle to change based upon the eccentricity of the cam. Since the motion of the pattern is controlled manually, distortion is introduced to the resultant PMP scan based upon the velocity of motion of the mechanical system.

For example, the computer controlled PMP capture process can be thought of as a discrete-time systemof the projected patterns. The pattern that represents a specific phase shift is projected onto the object, the camera captures that image, and then the new pattern with incremented phase is projected. This is repeated until the pattern has been shifted a full period, and only those signals at distinct phase shifts are ever projected upon the object. In contrast, the RAHAS technique can be thought of as an analog-to-digital conversion. The process uses a slide projector, which is controlled with a hand-turned lever and crank, that continuously varies the phase of the pattern across the surface of the object. The camera captures the images of the pattern on the surface at discrete-time intervals related to the video rate of the camera.

FIG. 10, graphically represents time-varying signal at a pixel: A representation of the sinusoidal signal at a pixel, and how it changes with non-constant pattern motion. The signal in green with empty circles at the sample points is the ideal sinusoidal response, and what would be achieved with computer controlled PMP. The signal in red with filled in circles is the actual response of a pixel in the River Scan 2 (see FIG. 21), that demonstrates the distortion from manual motion.

As opposed to the computer-generated PMP's succession of precisely shifted images, the instant technique is adapted for manual control of the phase-shift of the pattern. This manual control causes the translational motion of the projected pattern to have non-constant motion, which causes the sinusoidally varying temporal responseof a single pixel to distort. The temporal response of each pixel is vital to the success of PMP because this distortion is frequency or time dependent, which can obscure the phase information for accurate identification of pixels in triangulation. The distortion can be characterized by a temporal compression or rarefaction of the expected sinusoidal shape, which is a change in the frequency spectra of the signal.

The flow diagram FIG. 9 gives an overview of the Post-processing of the 3-D video sequence acquired on-site. First shown is a pre-processing step that prepares the image data for snake tracking. Next is snake tracking, which is followed by the phase processing of the PMP scan.

### Pre-Processing the Images

The computer-implemented process begins by loading and preparing a sequence of images that have captured the SLI pattern motion, described in the previously. The sequence of images are normalized, to balance the slight variations when using an automatic camera, and filtered, in order to remove noise and smooth the images for ease of snake tracking. Two filters are used, a median filter and a moving average filter, both with rectangular kernels.

After the images are filtered, a rotation is performed on each image in the sequence to orient their stripes to the phase direction, shown in FIG. 11. The purpose of this “un-rotation” of the image sequence is to allow the peak detection to only have to operate in a single dimension. As the sequence progresses, the stripes distort, but retain the alignment. With low angular velocity of the pattern, the precise angle of “un-rotation” is not necessary because the stripes will distort with small changes between frames, and will be able to be tracked frame-by-frame. FIG. 11 is a graphic representing demonstration of the “un-rotation” of the pattern sequence with the same images from FIG. 4 (a, b, and c). In FIG. 11, the top is the image rotated so that the stripes are horizontal, and the bottom images are the snakes of the same image. At Epipolar alignment in the first frame of the sequence (a), the “un-rotation” angle is 90°, while decreasing to an “un-rotation” angle of 0° during the PMP scan (b).

The angle of rotation for each image in the sequence is determined by the equation

$${θ}_{rotation} = 90 ° \frac{N - ( n - 1 )}{N} \qquad ( 3.1 )$$

where N denotes the number of frames in the rotation sequence, and n is the frame index. The angles with relatively flat target surfaces could alternatively be determined using a 2-D FFT and measuring the angular displacement of the peaks corresponding to the sinusoidal pattern. This method worked well for image frames in which the stripes were straight, but when surface changes distorted the stripes to oblique angles, like what occurs when projecting onto the calibration grids, this approach does not work reliably.

### Peak Detection and Snake Masking.

The definition of a snake specifies that they be placed along the stripes of the sinusoidal pattern that is used for the PMP scan. In order to “snake” an image, the peak position of the stripes must be determined. The determination of the peak locations is by the usage of a peak-to-sidelobe-ratio (PSR) operation performed on the image frame Aᵢ(x,y), and found in the functionanglePSR. This function generates a separate image Aₚₛᵣ (x,y) through the equation

$${A}_{psr} ( x , y ) = \frac{{A}_{i} ( x , y )}{Max ( {A}_{i} ( x , y - r ) , {A}_{i} ( x , y + r ) \}} \qquad ( 3.2 )$$

where r is the expected sidelobe offset.

Next a function called snakeMaskPeakPSR generates the Snake Mask image, D, that has the position of the snakes in each image highlighted. The first step in the function snakeMaskPeakPSR is a thresholding operation on the PSR image, Aₚₛᵣ(x,y), with user defined minimum PSR value, min_{A}, and minimum pixel value of A, minₚₛᵣ, such that

$${A}_{psr}^{′} ( x , y ) = \{ \begin{matrix}{A}_{psr} ( x , y ) & \begin{matrix}where {A}_{i} ( x , y ) \geq {min}_{A} and \\ {A}_{psr} ( x , y ) \geq {min}_{psr}\end{matrix} \\ 0 & otherwise\end{matrix} \qquad ( 3.3 )$$

Next, a vertical search is performed on the resulting thresholded image, A′ₚₛᵣ, to find regions of non-zero values, so that the maximum values in these regions can be determined such that the region S is defined by

Sε{s₀,s₀+1, . . . ,s₁−1,s₁} where s₁>s₀

and

A′ₚₛᵣ(x,s₀−1)=0 and A′ₚₛᵣ(x,s₁+1)=0 and A′ₚₛᵣ(x,S)>0 (3.4)

with s₀ as the lower bound and s₁ as the upper bound of the region S.

The binary encoding is defined by

D(x,y)=255

where

A′ₚₛᵣ(x,y)=Max{v|v=A′ₚₛᵣ(x,y+S) and Sε{s₀,s₀+1, . . . ,s₁−1,s₁}} (3.5)

so that the resultant image is the binary Snake Mask image, D, that has zeros everywhere, except where the PSR of the image frame A has local maxima. These local maxima correspond to the centers of the stripes in the sinusoidal pattern, and the location of snake pixels that will be named and tracked.

### Snake Matrix Initialization

Snakes are initially identified in the first frame of the sequence with the function SnakeFind_init2Snake, which operates on the image D after the number of snakes and their spacing is determined. The findNumSnakes function generates the number and the spacing of the snakes by using a 2-D FFT on the first frame, the frame with undistorted stripes, to determine the frequency of the sine pattern.

The Snake Mask D is processed using SnakeFind_init2Snake to label the snakes in a narrow vertical band in the middle of the image. The function collapseSlice is used to average the location of the snakes in the D matrix to give a position for the start of the search algorithm. FIG. 13 is a flowchart representing the SnakeFind_init2Snake function.

With the width of the image, Nₓ, the midpoint is

$${x}_{mid} = floor ( \frac{{N}_{x}}{2} ) .$$

The collapse equation can be described by the equation

$${r}_{s} ( y ) = {\sum }_{i = - {d}_{m}}^{{d}_{m}} d ( {x}_{mid} + i , y ) \qquad ( 3.6 )$$

where dₘ is the radius, in the x-direction, of the vertical band about the midpoint. The output rₛ is a 1-D vector that is searched by the function findCollapsePeaks to find where the summations from the collapse were the largest. The search process can be described by

$${r}_{peaks} ( y ) = \{ \begin{matrix}1 & \begin{matrix}\begin{matrix}\begin{matrix}\begin{matrix}\begin{matrix}where {r}_{s} ( y ) > {r}_{s} ( y \pm 1 ) \\ where {r}_{s} ( y ) = {r}_{s} ( y + 1 ) and\end{matrix} \\ {r}_{s} ( y ) > {r}_{s} ( y + 2 ) and\end{matrix} \\ {r}_{s} ( y ) > {r}_{s} ( y - 1 )\end{matrix} \\ \begin{matrix}\begin{matrix}where {r}_{s} ( y ) = {r}_{s} ( y + 1 ) and \\ {r}_{s} ( y ) = ( y + 2 ) and\end{matrix} \\ {r}_{s} ( y ) > ( y - 1 ) and\end{matrix}\end{matrix} \\ {r}_{s} ( y ) > {r}_{s} ( y + 3 )\end{matrix} \\ 0 & otherwise\end{matrix} \qquad ( 3.7 )$$

where rₚₑₐₖₛ is a 1-D vector that has length My, the height of the image, and has a value of 1 where the snakes are located. Since the indexes into rₚₑₐₖₛ(y) correspond to y-coordinates in the center column of the image, the final step is to store all the indexes (or y-coordinates of the snakes) that have been flagged as a snake into the vector s_{locs}. This allows the recovery of the snake y-coordinate values by iterating through the elements of the vector s_{locs}, and serves as a starting point for the region searched in the next part of this algorithm. This region is defined by a fixed maximum distance in the vertical direction, deltaY=10 pixels, and the horizontal direction, deltaX=5 pixels, although the pixels are searched starting with the central points column and only searching adjacent columns if no snake pixel is found. An overview of the process can be seen in FIG. 3.5 and the mathematics can be characterized by

$${Si}_{n} ( {x}_{mid} + {j}_{o} , i ) = i \\ {Sy}_{n} ( {x}_{mid} + {j}_{o} , i ) = {s}_{locs} ( i ) + {k}_{o} \\ {Sp}_{n } ( {x}_{mid} + {j}_{o} , i ) = {A}_{n} ( {x}_{mid} + {j}_{o} , {s}_{locs} ( i ) + {k}_{o} ) \\ else 0 \\ where \\ [ {j}_{o} , {k}_{o} ] = Min \{ j , k \vert \begin{matrix}{D}_{n} ( {x}_{mid} + j , {s}_{locs} ( i ) + k ) = 255 and \\ - 5 < j < 5 and - 10 < k < 10\end{matrix} \} \qquad ( 3.8 )$$

The result of the SnakeFind_init2Snake function is the labeled identity of each snake, although only for a single pixel. The next step is to “grow” the snakes from these single pixels.

### SnakeFind_grow[Left|Right]

Now that there is a single pixel identified for each snake, these lone pixels can be “grown” horizontally to fill out the rest of the snake in Si. The snakes will be expanded by a single pixel at a time, until the end of the image has been reached, an annomally prevents snake detection, or a large shadow exists on the object to prevent growth. This expansion process is performed by the functions SnakeFind_growLeft and SnakeFind_growRight, which will also be used to fill in holes in the snakes during the snake tracking. While we will discuss the algorithm specifically for growRight, the only difference between the two (Right or Left) is a change of orientation.

The equations describing the growRight process are as follows

$${Si}_{n} ( x , {m}_{s} ) = \{ \begin{matrix}1 & \begin{matrix}if {Si}_{n} ( x - 1 , {m}_{s} ) > 0 and \\ {D}_{n} ( x + {j}_{o} , y + {k}_{o} ) = 255\end{matrix} \\ 0 & otherwise\end{matrix} \\ where \\ [ {j}_{o} , {k}_{o} ] = Min \{ j , k \vert \begin{matrix}{D}_{n} ( {x}_{mid} + j , {s}_{locs} ( i ) + k ) = 255 and \\ 0 < j < {x}_{mgrow} and - {y}_{mgrow} < k < {y}_{mgrow} \end{matrix} \} and y = {Sy}_{n} ( x , {m}_{s} ) \qquad ( 3.9 )$$

where x_{mgrow} and y_{mgrow} are values that define the maximum distances to search in their respective directions.

The grow functions begin by searching through a snake row in the Si matrix looking for the “end” of a snake, which corresponds to the current pixel being “blank” (Si(x,mₛₙₐₖₑ)=0) and the previous pixel being “active” (Si(x,mₛₙₐₖₑ)>0). When the “end” of the snake is found, a search is performed for the “valid” (D(x,y)=255) snake pixel in the Snake Mask D with minimum distance to the location of the active pixel at the end of the labeled snake. This search of D starts at the current pixel's column, x, and the previous “active” pixel's y coordinate, determined from the Sy matrix y=Sy(x±1, mₛₙₐₖₑ). The search progresses in single pixel increments, both up and down, until a valid pixel is found, or a y-search limit has been reached. If the y-search limit has been reached, then the search continues in the next column (in the direction of the grow) starting at the same y coordinate and repeating the vertical search. This is repeated until a valid pixel is found in D and stored into {Sp, Sy, Si}, or the x-search limit is reached, in which case the current “end” of the snake is left alone and a new “end” is sought to repeat the same process. Using the SnakeFind_grow[Left|Right] functions, whole snakes can be formed in the initial image, and the tracking of the snakes can begin. FIG. 14 is a flowchart of the SnakeFind_growLeft/Right function. The horizontal direction of grow corresponds to the name of the function: left or right.

### Snake Tracking

Due to the orientation of the snakes in the horizontal direction (from the “un-rotation” of the images) and the slow movement of the pattern relative to the image capture rate, a snake pixel is assumed to only shift a small amount in its column between image frames. These small variations allow a search in the snake pixel's column to find the location that the snake pixel has shifted, as long as the shift was within a maximum allowable distance. By finding the position of each pixel in the snake after it has shifted, the snakes can be tracked between two frames. If this is continued frame after frame, snake tracking in a whole sequence of images can be accomplished. An overview of the overall snake tracking process is presented in FIG. 15.

The SnakeFind_multiPassTrackDeltaY function performs snake tracking after the first frame's snakes have been identified, and continues through the whole image sequence. The notation used for the sequence is as follows: n, denotes the current frame, and N, denotes the total number of frames. The snakes are tracked by comparing the marked pixels in the Snake Mask of the current frame (Dₙ) to the snake pixels in the Snake Matrices of the previous frame {SpB4, SyB4, SiB4}, and determining whether the snake pixel identified in the previous frame has moved within a maximum acceptable vertical distance y_{mtrack}) in its respective column. The equations describing this function are as follows

$${Si}_{n} ( x , {m}_{s} ) = \{ \begin{matrix}1 & \begin{matrix}if {Si}_{n - 1} ( x , {m}_{s} ) > 0 and \\ {D}_{n} ( x , y + {k}_{o} ) = 255\end{matrix} \\ 0 & otherwise\end{matrix} \\ where \\ {k}_{o} = Min \{ \begin{matrix}k \vert {D}_{n} ( x , y + k ) = 255 and \\ - {y}_{mtrack} < k < {y}_{mtrack}\end{matrix} \} \\ and \\ y = {Sy}_{n - 1} ( x , {m}_{s} ) \qquad ( 3.10 )$$

where mₛ is the snake that is currently being operated on, which also corresponds to the row of the Snake Matrices, and y_{mtrack} is the maximum distance to search in the vertical direction.

The multiPass designation means that the process was performed twice, once starting with the first snake and proceeding top-down, and a second time starting with the last snake, and proceeding bottom-up. Both of these snake matrices are generated, compared, and only the pixels that tracked the same in both passes are kept, or the output is the intersection of the sets of “top-down” and “bottom-up”. The multiPass process can be characterized by

Siₙ=Si_{nDown}∩Si_{nUp} (3.11)

where Si_{nDown} and Si_{nUp} are both determined from Equation 3.10, but using opposite directions for processing the snakes. Si_{nDown} begins at the top and works down (from snake 1 to N), while Si_{nUp} begins at the bottom and works up (from snake N to 1).

The process begins at either the first snake or the last snake in the previous frame's snake matrices {SiB4, SyB4, SpB4} depending on the pass direction that is being processed, with the other direction to be processed after, and the intersection of both passes as the final result. For each snake (mₛ) in the snake matrix SiB4, the snake pixels are looped through and processed if the pixel is active (SiB4(x, mₛ)>0). When an active snake pixel is found, the snake pixel's image y-coordinate, y=SyB4(x,mₛ), is used as a starting point for a search in the current Snake Mask Dₙ(x,y). The search progresses in single pixel increments, both up and down, until a valid pixel is found, or the y-search limit (y_{mtrack}) has been reached. If a valid pixel is found then it is stored in the current Snake Matrix set {Siₙ, Syₙ, Spₙ}, and the process proceeds to the next snake pixel. The process also proceeds to the next snake pixel if the search reaches the limit without finding a valid pixel in the Snake Mask. This continues through all the pixels in the current snake, then checks the subsequent snakes (either above or below depending on the pass direction). After all the snakes in a frame are processed, and the intersection of the multiPass has been determined as in Equation 3.11 the function SnakeFind_multiPassTrackDeltaY generates a set of Snake Matrices that correspond to the current frame {Siₙ, Syₙ, Spₙ}. This set of Snake Matrices is processed with SnakeFind_multiPassGrow[Left|Right], as discussed above, but with a multiPass addition, to attempt at filling in any holes that could not be tracked. Now the Snake Matrix set {Siₙ, Syₙ, Spₙ} is stored as the previous set {SiB4, SyB4, SpB4}, and the current frame is incremented—the process repeats to the end of the image sequence. FIG. 16 is a flowchart illustrating the SnakeFind_trackDeltaY function.

The phase processing begins after the snakes have been tracked through both the rotation and translation of the sinusoidal pattern, and the snake positions in the image plane are known explicitly. The snake positions will be used in the unwrapping stage to remove the ambiguities of the high frequency PMP scan, and in the estimation of pattern motion used in the correction process. The motion of the sinusoidal pattern (translation in the phase direction) defines the PMP scan stage, but a problem arises due to the motion generated by a hand turned crank. The velocity of the pattern is not constant, so the frame captures of the video camera are not uniformly spaced in the phase of the sinusoidal pattern.

### Phase Algorithm

The Phase processing begins with determination of the frames in the PMP sequence. The first frame of the PMP sequence is chosen manually by visual inspection of the video sequence for the frame in which the translation is first noticeable, but the actual number of frames must be determined using the snake positions of this first frame. Using the definition of the pattern as a sinusoid and the location of the snakes at the peaks of the sinusoidal pattern, the vertical distance between two adjacent snakes should be the phase equivalent of 2π, or a single period of a sine wave. Taking advantage of this relationship allows the snake locations to determine when the pattern has moved a distance that would correspond to a full period, and will give the final frame of the sequence.

In the first frame, the y-coordinate of a snake is defined by y₀=Sy₀(x,mₛₙₐₖₑ), and the y-value that would correspond to a translation of 2π is the next snake's y-coordinate y_{N}=Sy₀(x,mₛₙₐₖₑ+1). The x denotes the column, and must be the same. After the initial and final y-values are determined from the first frame (denoted by the 0 subscript), they-value of the same snake in subsequent frames will be compared to y_{N}, they-value corresponding to a phase of 2π. The current frame's y-value is described by

yₙ=Syₙ(x,mₛₙₐₖₑ) (3.12)

where n corresponds to the current frame index. The frame index starts at 1, the first frame after 0 phase, and continues until the boundary of 2π is reached as explained by

nε{1,2, . . . ,k} where Syₖ(x,mₛ)<y_{N}<Syₖ₊₁(x,mₛ)) (3.13)

k is the last frame of the PMP sequence just before the y-value passes y_{N}. The Equations 3.12 and 3.13 define the search criteria for finding the end of the PMP sequence, as well as simultaneously performing a task to construct the per frame phase shift estimate, φₙ.

$${φ}_{n} = 2 π \frac{{y}_{n} - {y}_{0}}{{y}_{N} - {y}_{0}} \qquad ( 3.14 )$$

The phaseshift estimate between frames is based upon the snake distance moved per frame as a percentage of the total distance between snake mₛₙₐₖₑ and the adjacent snake mₛₙₐₖₑ+1 corresponding to the percentage of total phase. φₙ is the actual phase shift per frame and will be used to interpolate the images Iₙ(x,y). A visual representation of this phase shift estimating process is shown in FIG. 17. The sinusoidal pattern represents the projected pattern with tracked snakes superimposed on top. The triple lines are the snakes in the initial frame 0, and the dashed lines represent the position of snake mₛₙₐₖₑ in each of the subsequent frames denoted by the subscripts(0, 1, 2, . . . , n).

FIG. 17 graphically depicts a Phase Estimate Example: Visual Representation of how the phase is estimated for each frame in the PMP sequence. The left side shows the change in the y-values of the snakes in the image pixels, while the right side shows the phase assigned for each snake.

### Phase Correction by Interpolation

In order to use the well-known PMP equations discussed in Chapter 2, the image values, Iₙ(x,y), need to be corrected and interpolated to the values at the uniformly distributed phase values described by

$${θ}_{n} = \frac{2 π n}{N} \qquad ( 3.15 )$$

where θₙ is the desired or corrected phase values per frame, n is the frame index and N is the total number of frames in the sequence. The interpolation process alters the pixel values in each image of the sequence using the following equations:

$$\begin{matrix}α = \frac{{φ}_{m + 1} - {θ}_{n}}{{φ}_{m + 1} - {φ}_{m}} where {φ}_{m} < {θ}_{n} < {φ}_{m + 1} \\ and & ( 3.16 ) \\ {I}_{int , n} ( x , y ) = α {I}_{m} ( x , y ) + ( 1 - α ) {I}_{m + 1} ( x , y ) & ( 3.17 )\end{matrix}$$

where m is an index for the actual phase values denoting the indexes above and below the index n of the desired phase index. With the corrected images that are uniformly spaced in phase, the traditional PMP equations can be used.

### Generate Wrapped Phase

As presented in Chapter 2, the equation for the wrapped phase is

$${φ}_{w} ( {x}^{c} , {y}^{c} ) = arctan [ \frac{{\sum }_{n = 0}^{N} {I}_{int , n} ( {x}^{c} , {y}^{c} ) sin ( {θ}_{n} )}{{\sum }_{n = 0}^{N} {I}_{int , n} ( {x}^{c} , {y}^{c} ) cos ( {θ}_{n} )} ] \qquad ( 3.18 )$$

and the equation used for the quality image can be described as

$$Q ( x , y ) = \sqrt{{{( {\sum }_{n = 0}^{N} {I}_{int , n} ( {x}^{c} , {y}^{c} ) sin ( {θ}_{n} ) ) )}^{2} + ( {\sum }_{n = 0}^{N} {I}_{int , n} ( {x}^{c} , {y}^{c} ) cos ( {θ}_{n} ) ) )}^{2}} \qquad ( 3.19 )$$

The Q image acts as a measure for how good the scan is based upon the peak-to-peak temporal variation of the patterns at each pixel. The Q image should be a gay level image without the appearance of stripes or bands, and for traditional PMP this is the case, but for RAHAS bands are present and have not been able to be removed completely. This banding phenomenon will be discussed later.

### Unwrap the Phase

Now that the wrapped phase has been generated it must be unwrapped in order to combine the repeated phase bands into a whole phase image. As discussed earlier, the snakes are used to determine the boundaries of the wrapped phase image, but the first step is to linearly generate the correct phase at each snake boundary by the equation

$${θ}_{k} = 2 π \frac{k - 1}{{M}_{s}} \qquad ( 3.20 )$$

Equation 3.20 assumes a phase of zero at snake k=1, and a phase of 2π at the last snake Mₛ, which is the total number of snakes that were in the slide pattern. The phase is going to be used to map positions in the camera space to the projector space for triangulation, and we assume 0 phase at the top of the slide pattern, and 2π at the bottom of the slide pattern.

With the phase of each snake known in the projector space, the snakes are used as boundaries to unwrap the bands of the wrapped phase image. The unwrapping of each band is performed pixel-by-pixel and band-by-band by the equation

$${φ}_{UW} ( x , y ) = \{ \begin{matrix}{θ}_{k} + \frac{{φ}_{w} ( x , y )}{{M}_{s}} & where {Sy}_{0} ( x , k ) \leq y < {Sy}_{0} ( x , k + 1 ) \\ 0 , & where \vert {Sy}_{0} ( x , k ) - y \vert < 4\end{matrix} \qquad ( 3.21 )$$

In which k represents the current boundary, θₖ is the phase at the boundary, as determined from Equation 3.20, and the pixels within 4 pixels of the boundary are zeroed out to prevent discontinuous phase at the boundaries. For each band, the wrapped phase, φ_{W}, is simply added to the constant phase. FIG. 18 shows a typical wrapped phase image and the corresponding unwrapped phase image generated using Equation 3.21; FIG. 18(a) wrapped phase and FIG. 18(b) unwrapped phase. The wrapped phase image (a) is shown with four of the phase bands colored.

FIG. 19 graphically depicts Phase Cross-Sections: FIG. 19(a) is the cross-section of the wrapped phase at the center column; FIG. 19(b) is the unwrapped phase cross section (blue) is shown along side the wrapped phase cross section (black) to demonstrate how the unwrapped phase is a copy of the wrapped phase signal detail in each phase band. A single column of the phase images is presented as further explanation of the unwrapping process. The cross-sectional view shown in FIG. 19(a) shows the “repeated ramp” shape that is characteristic of wrapping phase, with each ramp corresponding to a specific phase band. In FIG. 19(b), the wrapped phase is shown on the same axis as the unwrapped phase ramp. Notice that the shape of both signals is identical in each vertical band corresponding to the wrapped bands of phase, and “repeated ramp” wrapped phase would be completely identical if each ramp had the corresponding phase value offset as detailed in Equation 3.21.

Since the unwrapped phase φ_{uw} is linearly distributed in the phase direction of the projector coordinates, the Equation 2.4 shows the relationship between the φ_{uw}(x^{c},y^{c}) phase image and a corresponding column on the projector image planey^{p}. The x-coordinate of a specific pixel (x^{p},y^{p}) along the column of the projector image plane equals the x^{c} coordinate due to the symmetry of the epipolar alignment of the projector and camera. Using Equation 2.17 the vector (x^{c},y^{c},y^{p}) generates a corresponding 3-D world coordinate point (X^{w},Y^{w},Z^{w}).

### Background: Glossary of Selected Terms Used Herein, by Way of Reference Only:

Lock—Aligning to set an Epipolar Alignment of an SLI pattern projected on a contoured surface-of-interest so as to initially assign an epipolar identity to each snake.

Hold—The unique process of capturing 3D motion using the continuously projected SLI pattern set during ‘Lock’ usually consisting of bands of light (with a sinusoidal cross section), to track whereabouts of illuminated stripes referred to as ‘snakes’.

A film frame, or just frame, is one of the many single consecutive images in a motion picture or video. Individual frames may be separated by frame lines. Typically, 24 frames are needed for one second of a motion picture (“movie”) film.

Frame rate, or frame frequency, is the measurement of the frequency (rate) at which an imaging device produces unique consecutive images ('frames'). The term is used when referring to computer graphics, digital or analog video cameras, film cameras, motion capture systems, and so on. Frame rate is often expressed in frames per second (fps).

Active—A pixel is called an “active” snake pixel when it gets included into the Snake Matrix Set and has a non-zero value in the Si matrix. “active” implies that the pixel is also “valid”

Blank—Calling a pixel “blank” refers to its zero valued entry into the Si matrix.

Snake—A snake is a stripe of single pixel width that is located along the stripes of the sinusoidally varying, or other SLI, pattern. For RAHAS processing, the snake identities are determined by SnakeFind functions and are stored in a Snake Matrix Set, which consist of three matrices {Si,Sy,Sp}.

Snake Matrix Set {Si, Sy, Sp}—A collection of three separate 2-D matrices that are used to identify and label snakes in a given image frame. The matrices are all the same size: the width is the width of the image, and the number of rows in the matrix corresponds to the number of snakes. Each entry in these matrices corresponds to a pixel on a snake, while a given row is a single snake. To index into a matrix, the x coordinate in the image is used along with the snake identity. For example, Sy(3,512) would return y coordinate of snake number 3 at the 512th column in the image.

Snake Identity Matrix, Si—The Si matrix is part of the Snake Matrix Set and is the indicator of whether a snake is valid or not. If a value of 0 is stored in the Si matrix, then the snake is not valid at that pixel. A value greater than 0 represents the identity given to the specific snake, and signifies an identified snake at the corresponding pixel. It is common to have snakes that do not span the whole width of the matrix, leaving gaps in the Si matrix to signify shadows on the object, undetected snake pixels, or that the stripe did not span the width of the image.

Snake Y Matrix, Sy—The Sy matrix is part of the Snake Matrix Set and holds the y-coordinate for the position of the corresponding snake pixel in the image. Since the snakes are oriented in the horizontal direction, the x values are used for indexing into the matrices

Snake Pixel Matrix, Sp—The Sp matrix is part of the Snake Matrix Set and holds the value of the pixel in the image that corresponds to that snake pixel.

Snake Mask, D—A trinary valued matrix the same size as an image in the capture sequence. D has the value 255 where the peaks of the snakes are located and a value of 128 transitioning between the peak locations and the rest of the image which is set to zero. The D image represents the pixels in the target image frame, A, that were identified as having peak characteristics of a snake.

Target Image, A—The target image A is the frame in the image sequence that is being processed. It is occasionally in the drawings, denoted as A.

Valid—A pixel is called a “valid” snake pixel when it has a value of 255 in the Snake Mask D matrix. While a valid pixel will usually be active in the Si matrix, it could have been missed in the identification process and still be un-labeled.

The capture unit 100, 200 of the system may not be resting on a tripod but rather floating or moving, such as is the case in operation at a steady motion to scan long objects-of-interest. An operator of the system may use a mechanical switch to initiate the slide rotation process which could be driven by a motor while the unit is relatively stationary. Once the SLI pattern has been rotated a preselected amount, from its initial epipolar 90-degrees and into the orthogonal direction, the SLI pattern is held stationary while the scanner is moved linearly across the target surface-of-interest. Preferably, in this case, minimal movement is experienced by the unit during SLI pattern rotation step, and then approximately linear motion during the “PMP” scan step.

There are three new functions that are performed, in the case of moving the scanner linerarly along the target surface-of-interest to process the data:

1. Detect and Correct any object motion.

2. Detect Pattern Incoherent Shifting after the object motion correction.

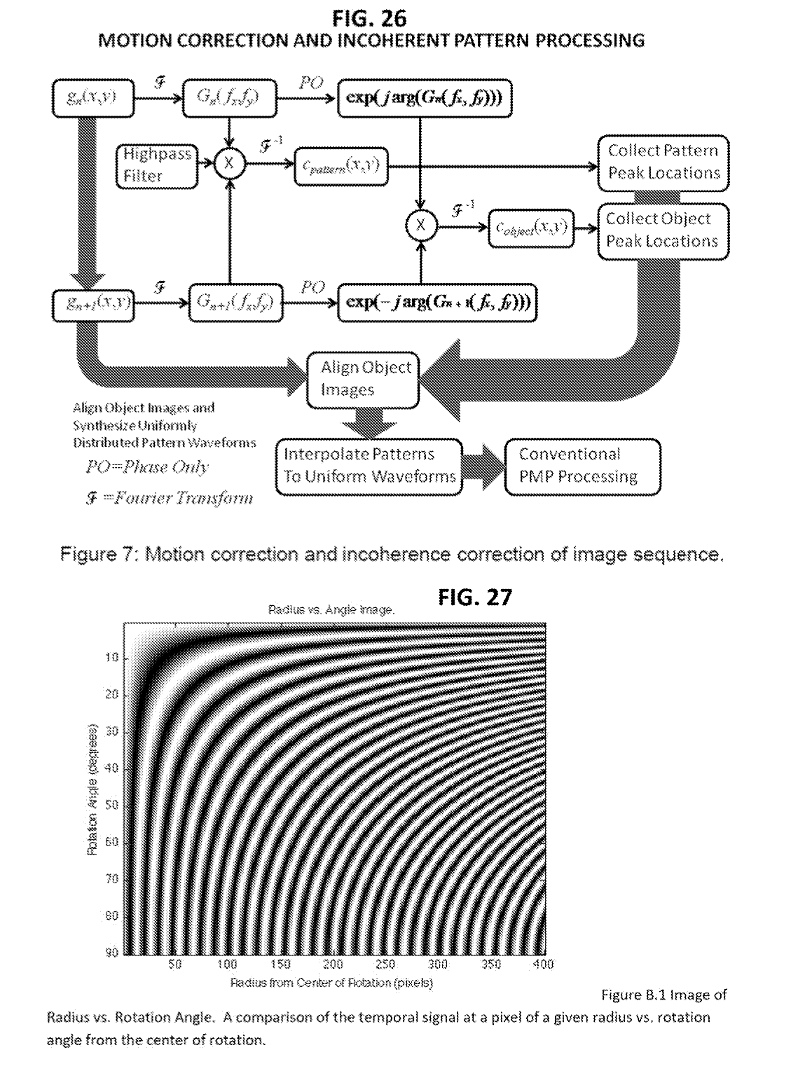

3. Correct Pattern Incoherence by interpolating pattern shifts so that they are uniformly distributed and a conventional processing step can be used to evaluate the phase. Referring to FIG. 26 detection of object motion can be done using cross correlation. One difficulty, is that the dominating spatial signal is the pattern projection, not the object. To address this problem a “fractional power” (FP) correlation filter may be employed and set to “phase only” mode which weights all spatial frequencies equally. Refer, also, to Kumar, B. V. K. Vijaya and Hassebrook, L., Performance measures for correlation filters, APPLIED OPTICS, Vol. 29, No. 20 (10 Jul. 1990) 2997-3006 (labeled and included as ATTACHMENT B hereof incorporated by reference). The Fourier transform of the nth image is Gₙ(fₓ,f_{y})=F{gₙ(x,y)} so the cross correlation using a phase only FP is

c_{object}(x,y)= [symbol] ⁻¹{exp(j arg(Gₙ(fₓ,f_{y})))exp(−j arg(Gₙ₊₁(fₓ,f_{y})))}

Once the spatial shift between image frames is detected by c_{object}(x,y) then we correct by translating one of the image frames. After all the correction translations are implemented, the images are then correlated as FP filters set to “matched filter” mode with “dc” suppressed such that

cₚₐₜₜₑᵣₙ(x,y)=F⁻¹{Gₙ(fₓ,f_{y})G*ₙ₊₁(fₓ,f_{y})H_{HP}(fₓ,f_{y})} (3)

where H_{HP} is a high pass filter used to suppress the “dc” and very low frequencies. The peak locations of the pattern correlation are used to determine the interpolation weights that generate the uniformly shifted (i.e., coherent) patterns needed for the PMP calculations. The flowchart in FIG. 26 shows the entire process of motion correction and incoherence correction.

The technique uses the rotation of the pattern to “hold” onto the stripes in order to remove ambiguities of a high frequency PMP scan. The geometry of the novel technique disclosed herein, opens up the possibility of rotation based encoding methods for projector-camera space mapping.

The image of a rotating sinusoidal pattern in projector space can be described by the equation

$${I}_{θ}^{p} ( {x}^{p} , {y}^{p} ) = {A}^{p} + {B}^{p} cos ( 2 π {k}_{c} ( sin ( θ ) \frac{( {y}^{p} - {y}_{0}^{p} )}{{M}_{y}} + cos ( θ ) \frac{( {x}^{p} - {x}_{0}^{p} )}{{N}_{x}} ) ) \qquad ( B .1 )$$

where θ^{p} is the angle of clockwise rotation, k_{c} is the frequency of the sinusoidal pattern, (x₀^{p}, y₀^{p}) is the center of rotation, and (Nₓ, M_{y}) are the dimensions of the image.

In PMP, the linear translation of a sinusoidal pattern generates a sinusoidal signal at each pixel. Similarly, the rotation of a pattern will generate chirp shaped signals at each pixel whose characteristics are determined by the angle θ^{p} and radius r^{p} of the pixel from the center of pattern rotation.

To further illustrate the characteristic patterns generated at each pixel, the Equation 2.2 for a PMP image in Cartesian coordinates (x^{p}, y^{p}) can be converted to polar coordinates (r^{p}, θ^{p}) as in the equation

$${I}_{n} ( {r}^{p} , {θ}^{p} ) = A ( {r}^{p} , {θ}^{p} ) + B ( {r}^{p} , {θ}^{p} ) cos ( 2 π {k}_{c} \frac{{r}^{p} sin ( {θ}^{p} - \frac{π n}{2 {N}_{x}} )}{{M}_{y}} ) \qquad ( B .2 )$$

where r^{p} denotes the radius in the projector space, and θ^{p} is the rotation angle of the sinusoidal pattern. Using Equation B.2, an image Iₙ(r^{p}, θ^{p}) can be generated to display the relationship between pixel radius and angle, shown graphically in FIG. 27 representing Image of Radius vs. Rotation Angle: A comparison of the temporal signal at a pixel of a given radius vs. rotation angle from the center of rotation.

### Phase Measuring Profilometry (PMP): Background Discussion.

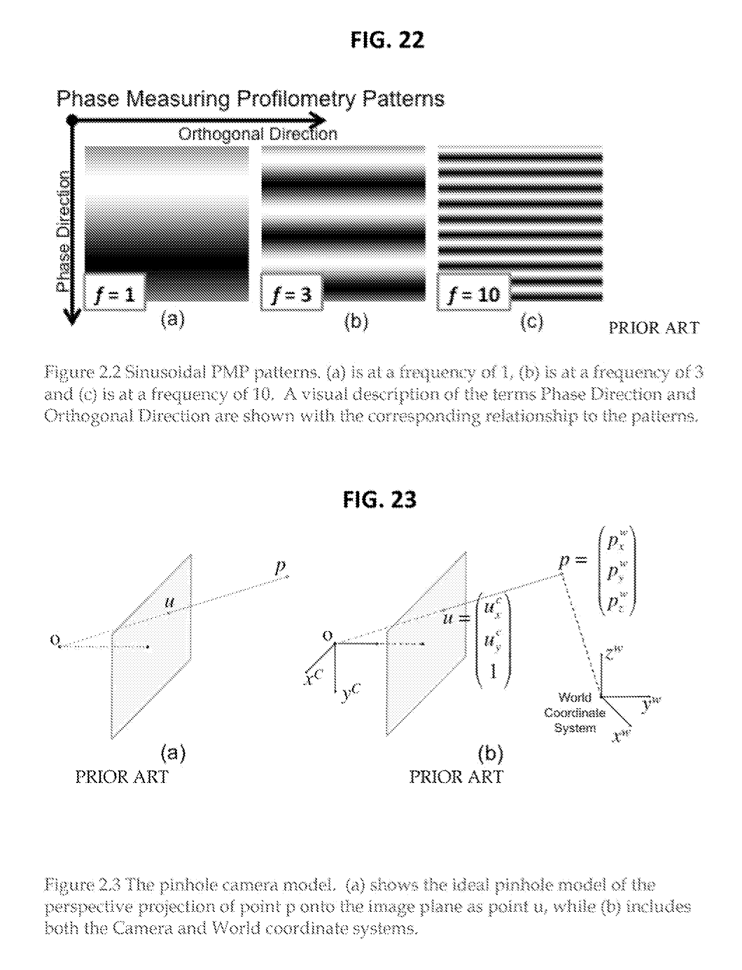

Phase Measuring Profilometry (PMP) is a known SLI technique that measures depth information from a surface using a sequence of phase shifted sinusoidally varying patterns. Much like how Binary Encoding uses a code sequence to identify pixels, a PMP pattern sequence can be thought of as encoding rows in the camera image with values that correspond to the phase shift of a sinusoid. The sequence of projected patterns generate a temporal signal at each pixel, such that the signal is a sinusoid, and the phase of the sinusoid is directly related to the position of the pixel along the Phase Direction. The pattern from the perspective of the projector can be described by the following equation

$${I}_{n} ( {x}^{p} , {y}^{p} ) = {A}^{p} + {B}^{p} cos ( 2 π {fy}^{p} - \frac{2 π n}{N} ) \qquad ( 2.2 )$$

where A^{p} and B^{p} are constants. The p superscripts denote the projector coordinates. The f is the frequency of the sine pattern measured in cycles per image-frame, N is the total number of phase shifts for the whole sequence, and n is the current phase shift index or current frame in the time sequence. Since the equation depends only on y^{p}, the intensity value of a given pixel, Iₙ(x^{p}, y^{p}), varies only in the y^{p} direction. This direction is called the Phase Direction of the PMP pattern because it is the direction of the phase shift. The term Orthogonal Direction is appropriately named for the relationship with the phase direction—it lies 90 degrees from the Phase Direction along the constant x^{p} values of the pattern. FIG. 22 shows examples of PMP patterns at three separate frequencies, along with corresponding Phase and Orthogonal Directions. FIG. 22(a) is at a frequency of 1, (b) is at a frequency of 3 and (c) is at a frequency of 10. A visual description of the terms Phase Direction and Orthogonal Direction are shown with the corresponding relationship to the patterns.

In order to triangulate to a specific point, the point's position in both camera and projector space must be known. While the camera position is known explicitly due to captured image being in camera space, the projector points are determined by matching a phase value measured at a point to that same phase value in the sinusoidally varying pattern as described in Equation 2.2. The phase value at each pixel in the camera space, φ(x^{c}, y^{c}), is determined by projecting N phase shifted patterns at the target and processing a sequence of N images by the equation

$$φ ( {x}^{c} , {x}^{c} ) = arctan [ \frac{{\sum }_{n = 1}^{N} {I}_{n} ( {x}^{c} , {y}^{c} ) sin ( 2 π n / N )}{{\sum }_{n = 1}^{N} {I}_{n} ( {x}^{c} , {y}^{c} ) cos ( 2 π n / N )} ] \qquad ( 2.3 )$$

where n denotes an index into the image sequence and Iₙ (x^{c}, y^{c}) is the pixel intensity value at the position (x^{c}, y^{c}) in the n^{th} image in the sequence.
For a pattern frequency of 1, which we will call the base frequency or a pattern of a single period of sinusoidal variation, the phase, φ, is easily mapped to a projector frame percentage along the Phase Direction by the equation

$${y}^{p} = \frac{φ ( {x}^{c} , {y}^{c} )}{2 π f} \qquad ( 2.4 )$$

Notice that y^{p} is not actually a coordinate in the projector space, but it is a value ranging from 0 to 1 that denotes a percentage of the distance between the bottom of the projector frame and the top.

An ambiguous phase problem occurs when increasing the frequency beyond 1 even though better depth resolution can be achieved through the use of higher frequency patterns. The problem is due to the periodic nature in sinusoids, and can be explained by examining the phase variation in φ(x^{c}, y^{c}) and comparing it to Equation 2.4. The variation in φ(x^{c}, y^{c}) is always from 0 to 2π but at f>1 Equation 2.4 will only vary between 0 and 1/f. So at higher frequencies, this creates what is called a repeated or Wrapped Phase image that requires unwrapping to fully acquire the unambiguous phase value for the correct y^{p} coordinate.

To take advantage of the benefits of higher frequency patterns on depth measurement, a technique called multi-frequency PMP was developed that uses lower frequency PMP scans to “unwrap” the phase for the higher frequencies, which allows for better accuracy with fewer number of frames.

Triangulation is based upon known geometric relationships to determine the points in a spatial coordinate system; therefore, it is important to the performance of any of these systems that the required geometric parameters be computed in a calibration process. Below, both the calibration procedure and the reconstruction method used are presented. To visualize triangulation, the simplistic pinhole model represented in FIG. 23 is used. The ‘ideal’ pinhole model (FIG. 23) is comprised of a single point o called the center of projection, and a plane termed the image plane. When a line is traced from a point in the 3-D world space to the center of projection the line intersects the image plane at a single point, at u. The mapping of the point p in the 3-D coordinate system to the intersected point, u, on the 2-D image plane is called the perspective projection and is described by the equation

$$λ ( \begin{matrix}{u}_{x} \\ {u}_{y} \\ 1\end{matrix} ) = ( \begin{matrix}{p}_{x} \\ {p}_{y} \\ {p}_{z}\end{matrix} ) \qquad ( 2.5 )$$

where the center of projection is located on the origin of the world coordinate system for the ideal model and λ is a non-zero scalar.

The camera coordinate system and world coordinate system are both represented in FIG. 23. The 3-D point p has world coordinates described by the vector p^{w}=(pₓ^{w}, p_{y}^{w}, p_{z}^{w})^{T} and camera coordinates described by the vector p^{c}=(pₓ^{c}, p_{y}^{c},p_{z}^{c})^{T}. These two vectors are related by the affine transformation specified by the rotation matrix Rε [symbol] ^{3×3} and the translation vector Tε [symbol] ³, such that

p^{c}=Rp^{w}+T (2.6)

The Equation 2.6 can be rewritten and combined with Equation 2.5 as

$$λ u = [ R \vert T ] [ \frac{{p}^{w}}{1} ] \qquad ( 2.7 )$$

Together (R,T) make up the extrinsic parameters of the camera by describing its orientation and location with respect to the world coordinate system. While the extrinsic parameters map the point p^{w} to p^{c}, the intrinsic parameters map the point p^{c} to the 2-D pixel image plane. To compensate for intrinsic parameters such as scaling differences between the image plane and the pixel coordinates, variations in focal length, or a skewed image plane from its actual orientation, a matrix Kε [symbol] ^{3×3} is introduced to the transformation such that

$$λ u = K [ R \vert T ] [ \frac{{p}^{w}}{1} ] \qquad ( 2.8 )$$

which can be further simplified to

$$\begin{matrix}λ u = M [ \frac{{p}^{w}}{1} ] \\ where & ( 2.9 ) \\ M = [ \begin{matrix}{m}_{1} & {m}_{2} {m}_{3} & {m}_{4} \\ {m}_{5} & {m}_{6} {m}_{7} & {m}_{8} \\ {m}_{9} & {m}_{10} {m}_{11} & {m}_{12}\end{matrix} ] & ( 2.10 )\end{matrix}$$

It can be shown that the world to pixel coordinate transforms for a pinhole model follows directly from Equation 2.9, which are

$$\begin{matrix}{x}_{c , n} = \frac{{m}_{1} {x}_{w , n} + {m}_{2} {y}_{w , n} + {m}_{3} {z}_{w , n} + {m}_{4}}{{m}_{9} {x}_{w , n} + {m}_{10} {y}_{w , n} + {m}_{11} {z}_{w , n} + {m}_{12}} \\ and & ( 2.11 ) \\ {y}_{c , n} = \frac{{m}_{5} {x}_{w , n} + {m}_{6} {y}_{w , n} + {m}_{7} {z}_{w , n} + {m}_{8}}{{m}_{9} {x}_{w , n} + {m}_{10} {y}_{w , n} + {m}_{11} {z}_{w , n} + {m}_{12}} & ( 2.12 )\end{matrix}$$

where n=1, 2, . . . , N points on a calibration target. These equations assume that the m₁₂ term is 1, so that the transformation is linear at the world origin. The calibration procedure generates an image of a calibration target with N points on the surface that have known values for (Xₙ^{w}, Yₙ^{w}, Zₙ^{w}, xₙ^{c}, yₙ^{c}) for each point on the target. Using this calibration procedure all the terms of the matrix M can be determined. It follows that both the matrix M^{c} for the camera coordinate system and the matrix M^{p} that represents the projector coordinate transformations are determined using the same method and can be found simultaneously.

A benefit of performing PMP in only the y^{p} direction is that the equations become simpler, and only three parameters (x^{c},y^{c},y^{p}) are necessary for triangulating the corresponding world coordinate for each pixel. Of the required parameters, the camera coordinates (x^{c},y^{c}) are known explicitly, while the y^{p} value is determined by the specific method for Structured Light Illumination. In this thesis, the y^{p} values are obtained from the unwrapped phase and the Equation 2.3. To obtain the world coordinate (X^{w},Y^{w},Z^{w}), it has been shown [36] that manipulation of Equations 2.11 and 2.12 leads to

$$[ \begin{matrix}{m}_{1} - {m}_{9} {x}^{c} & {m}_{2} - {m}_{10} {x}^{c} & {m}_{3} - {m}_{11} {x}^{c} \\ {m}_{5} - {m}_{9} {y}^{c} & {m}_{6} - {m}_{10} {y}^{c} & {m}_{7} - {m}_{11} {y}^{c} \\ {m}_{5}^{p} - {m}_{9}^{p} {y}^{p} & {m}_{6}^{p} - {m}_{10}^{p} {y}^{p} & {m}_{7}^{p} - {m}_{11}^{p} {y}^{p}\end{matrix} ] [ \begin{matrix}{X}^{w} \\ {Y}^{w} \\ {Z}^{w}\end{matrix} ] = [ \begin{matrix}{m}_{12} {x}^{c} - {m}_{4} \\ {m}_{12} {y}^{c} - {m}_{8} \\ {m}_{12}^{p} {y}^{p} - {m}_{8}^{p}\end{matrix} ] \qquad ( 2.13 )$$

and let

$$\begin{matrix}C = [ \begin{matrix}{m}_{1} - {m}_{9} {x}^{c} & {m}_{2} - {m}_{10} {x}^{c} & {m}_{3} - {m}_{11} {x}^{c} \\ {m}_{5} - {m}_{9} {y}^{c} & {m}_{6} - {m}_{10} {y}^{c} & {m}_{7} - {m}_{11} {y}^{c} \\ {m}_{5}^{p} - {m}_{9}^{p} {y}^{p} & {m}_{6}^{p} - {m}_{10}^{p} {y}^{p} & {m}_{7}^{p} - {m}_{11}^{p} {y}^{p}\end{matrix} ] & ( 2.14 ) \\ D = [ \begin{matrix}{m}_{12} {x}^{c} - {m}_{4} \\ {m}_{12} {y}^{c} - {m}_{8} \\ {m}_{12}^{p} {y}^{p} - {m}_{8}^{p}\end{matrix} ] & ( 2.15 )\end{matrix}$$

Now back substituting C and D into Equation 2.13, the equation becomes

$$C [ \begin{matrix}{X}^{w} \\ {Y}^{w} \\ {Z}^{w}\end{matrix} ] = D \qquad ( 2.16 )$$

and the world coordinate 3-D point can be obtained with

$$[ \begin{matrix}{X}^{w} \\ {Y}^{w} \\ {Z}^{w}\end{matrix} ] = {C}^{- 1} D \qquad ( 2.17 )$$

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶6 in a manner that unduly limits rights to its claimed invention. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A system for 3-dimentional image acquisition, using structured light illumination, of a surface-of-interest under observation by at least one camera, comprising a video sequence capture unit, the unit comprising:
(a) one or more image-capture devices for acquiring video image data as well as color texture data of a 3-D surface-of-interest, and
(b) a projector device for illuminating the surface-of-interest with a preselected SLI pattern in, first, an initial Epipolar Alignment and ending in alignment with an Orthogonal direction, and then shifting the preselected SLI pattern.
